(19) United States
(12) Patent Application Publication
(10) Pub. No.: US 2006/0243839 A9
(43) Pub. Date: Nov. 2, 2006

(54) Method and apparatus for measuring and adjusting the setting of a crusher

(75) Inventors: Paulo Barscevicius, Sorocaba (BR); Osmair Nunes Alves, Sorocaba (BR); Alfredo Maia Reggio, Sao Paulo (BR); Kimmo Kalevi Vesamaki, Kangasala (FI); Juha Tapio Potila, Pirkkala (FI); Esa Pekka Satola, Espoo (FI)

Correspondence Address: OLIFF & BERRIDGE, PLC, P.O. BOX 19928, ALEXANDRIA, VA, 22320, US

(73) Assignee: Metso Minerals (Tampere) OY, Tampere (FI)

(21) Appl. No.: 10/519,628

(22) PCT Filed: Jul. 2, 2003
(86) PCT No.: PCT/FI03/00535

§ 371 Date: Nov. 8, 2005

(30) Foreign Application Priority Data
Jul. 5, 2002 (FI) 20021327

(51) Int. Cl. B02C 25/00

(52) U.S. Cl. 241/261.2

(57) ABSTRACT

A method and apparatus are disclosed for measuring and monitoring the setting of a crusher, in which method the erosion of the wearing parts of the crusher are monitored by sensors capable of transmitting the measurement data to the crusher's automatic control system. Based on the received measurement data, the control system adjusts the crusher setting so as to maintain the setting at its predetermined value irrespective of the erosion of the crusher's wearing parts. The invention also relates to alternative embodiments of wear sensors for the wearing parts of a crusher. The measurement data indicating the amount of erosion in the wearing parts is transmitted wirelessly to the exterior side of the crusher.

The invention relates to crushers. More specifically, the invention relates to the measurement and adjustment of the setting of a crusher so that the set position of the setting of the crusher can be maintained constant irrespective of the erosion of the crusher's wearing parts. The invention also relates to alternative embodiments of wear sensors for the erosion indication of the wearing parts of a crusher.

Cone crushers have a vertical eccentric shaft with an inclined inner bore made thereto. Into the bore is fitted the main shaft of the crusher, generally having a support cone mounted thereon. The support cone is surrounded by the crusher frame having mounted therein an outer wearing member, generally known as the bowl liner. Respectively, onto the support cone is mounted another, inner wearing member, generally known as the head liner. The head liner and the bowl liner define a crusher chamber wherein the crushing of the infeed material takes place. With the rotation of the eccentric shaft, the main shaft as well as the support cone therewith are set into an oscillatory motion, whereby the gap between the head and the bowl at any give point therebetween varies during each rotation. The minimum gap width during one full rotation is called the crusher setting and, respectively, the difference between the gap width maximum and minimum is called the crusher stroke. By adjusting the crusher setting and stroke, as well as the rotating speed of the crusher, it is possible to modify such operating variables as the particle size distribution of the crushed rock and the production capacity of the crusher.

Often also the upper end of the crusher main shaft is supported to the crusher frame by an upper support bearing. Hence, this type of cone crusher is generally known as a gyratory crusher.

A gyratory crusher is generally made adjustable by means of a hydraulic system that permits the main shaft to be movable in the vertical direction in regard to the crusher frame. As a result, the crusher setting may be varied so that the particle size of the crushed rock meets the particle size specification of the current order and/or the crusher setting is maintained constant irrespective of the wear of the crusher liners.

In other types of cone crushers, the crusher setting adjustment may alternatively take place by elevating or lowering the crusher upper frame with the crusher head mounted thereto in regard to the crusher lower frame and the main shaft whose vertical position in regard to the crusher lower frame is fixed.

In impact crushers, the crushing of the infeed material takes place between a rotating rotor equipped with breaker bars and breaker plates mounted on the interior walls of the crusher frame. This kind of crusher has a plurality of breaker plates placed at different distances from the rotor so that a gradual reduction of the infeed material to be crushed is obtained. The crusher setting that controls the final aggregate size of the crushed rock is determined by the set position of the last breaker plate in the travel direction of aggregate material through the crusher. To protect the breaker plates, wearing elements are attached on those outer areas of the breaker plates that act as the crushing surfaces.

Impact crushers may have a horizontal or vertical construction.

In jaw crushers, the crushing cavity comprises two opposed jaws, of which one is fixedly mounted on the crusher front frame while the other jaw is a movable jaw connected to an oscillating element called a pitman, together with side plates that join the front frame of the crusher to its rear frame. The crushing cavity formed between the crushing jaws is a downward tapering gap, whereby the distance between the lower edges of the jaws is called the crusher setting. Through the eye of the pitman is passed an eccentric shaft that is mounted in bearings on the crusher side plates and the pitman. The eccentric shaft is connected to a flywheel rotated by external drive machinery. With the help of the eccentric shaft, the movable jaw connected to the pitman is forced to perform a substantially elliptic crushing motion in regard to the fixed jaw. Generally, the setting of a jaw crusher is adjusted by means of setting adjustment wedges which are adapted to the crusher rear frame so that sliding the wedges against a toggle plate inside the crusher rear frame causes the position of the lower edge of the movable die plate to shift in regard to the crusher rear frame and, thus, in regard to the fixed jaw. Also other kinds of setting adjustments are known, one of such being disclosed in patent publication U.S. Pat. No. 4,927,089.

However, no technology is available today for monitoring the actual value of crusher setting. Conventional technology offers only facilities for monitoring the mutual position of crusher parts related to crusher setting adjustment and support of wearing parts. This information, however, is not sufficient to facilitate the automation of the crusher setting adjustment inasmuch as neither the actual thickness of the wearing part nor its wear rate can be determined. Conventionally, compensation of wear has been carried out by first performing scheduled inspections of crushing wearing parts and, as a result thereof, then estimating the future need for setting adjustment. Due to wide variations of rock type even in a single quarry, this approach has not proven particularly reliable.

In patent publication U.S. Pat. No. 6,129,297 is disclosed one method of monitoring the progress of wear in the wearing parts of a crusher. According to this invention, on the rear surfaces of the wearing parts in the crusher are made recesses reaching up to a depth that represents the maximum allowable degree of wear of the wearing parts in the crusher. The recesses are filled with a suitable material such as a color composition. When the erosion of the wearing parts eventually reaches a point that reveals the recesses, the color composition spreads onto the surfaces of the wearing parts of the crusher, wherefrom the wear indication is easy to detect by the crusher operator. However, this kind of arrangement fails to provide on-line wear information during crushing inasmuch as the crusher must always be stopped for inspection thus causing losses in production capacity. Moreover, the embodiment according to cited publication invariably involves a risk of operator safety, since the crusher operator must climb onto the crusher to see whether the color composition is already visible in the crushing chamber. Hence, this kind of arrangement does not offer real-time monitoring of the erosion of wearing parts as it only indicates the terminal point at which the wearing parts of a crusher must be replaced.

Sensors suitable for condition monitoring of wearing parts in crushers are known in the art from patent publications DE 43 12 354 and DE 43 08 272, wherein the function of disclosed wear sensors is based on an electrical circuit comprising series-connected resistors. The wearing portion of the sensors incorporate conductors that break with the erosion of the wearing part thus either increasing or decreasing the resistance of the sensor circuit.

In patent publication FI 96924 is disclosed a gyratory crusher hydraulic control system having a hydraulically supported main shaft. Herein, the crusher setting can be adjusted by controlling the amount of hydraulic fluid pumped into a cylinder situated at the lower end of the main shaft, whereby the main shaft together with the head cone mounted thereon is elevated/lowered in regard to the crusher frame.

The method according to claim 1 and apparatus according to claim 3 now disclose an arrangement for measuring and monitoring the set position of a crusher during crushing, whereby also sensors for measuring the amount of erosion in the wearing parts of a crusher are disclosed in claims 9, 11 and 16.

In the method according to the invention, the erosion of wearing parts in a crusher is measured on-line during the operation of the crusher thus allowing the setting of the crusher to be controlled to a constant value irrespective of the erosion of the wearing parts.

The apparatus according to the invention facilitates real-time wear monitoring of crusher wearing parts with the help of wear sensors installed therein. Subsequently, the measurement data indicating the degree of wear in the crusher wearing parts is transmitted to the alarm system or automatic control system of the crusher. Also the crusher setting adjustment means are provided with sensors capable of measuring the position of the support surfaces of the crusher wearing parts relative to each other. Subsequently, also the measurement data indicating the relative positions between the support surfaces of the crusher wearing parts is transmitted to the automatic control system of the crusher. With the help of the measurement data indicating the wear situation of the crusher wearing parts and the measurement data indicating the relative position between the support surfaces of the crusher wearing parts, the crusher's automatic control system adjusts the position of the support surfaces of the crusher wearing parts thus maintaining the crusher setting constant irrespective of the wear of the crusher wearing parts.

In the apparatus according to the invention, information transmission may alternatively be advantageously implemented by wireless techniques. Herein, the thickness sensor of the wearing part is complemented with means for wireless transmission of information to the exterior of the crusher, whereby the external control system includes means for reception of the transmitted information. This kind of sensor system may also be complemented with an integral power supply generating the electrical energy required in the operation of the system, thus allowing the sensor system to be advantageously constructed into a self-contained entity incorporated in the wearing part of the crusher so as to move therewith. As a result, problematic wiring for information transmission and power feed can be disposed with.

Power feed for the sensors may be implemented using a battery, for instance. Alternatively, electricity for the sensors may also be generated from the motion of the crusher wearing parts with the help of a device that converts kinetic energy into electric energy. Such arrangements are known from wristwatches, for instance. The necessary electric energy may also be produced with a piezoelectric device or captured by means of, e.g., RF techniques from an electromagnetic field surrounding the crusher.

In its simplest configuration, the information gathered by the apparatus according to the invention is employed as the input information to the alarm system of the crusher, whereby the crusher operator is warned by the alarm system when the wearing parts of the crusher are about to run out.

One embodiment of a sensor developed for use in the apparatus according to the invention comprises a resistor network embedded in a wearing part of the crusher such that the resistance of the resistor network changes with the erosion of the wearing part thus delivering a measurement signal that changes with the amount of erosion.

The wear sensor outlined above facilitates the measurement of wearing parts in real time without calibration operations. Based on the degree of wearing parts wear computed from the wear measurement data, the setting of the crusher can now be identified more accurately than in the prior art. Simultaneously, also the wear monitoring of the crusher wearing parts (e.g., in percent), estimation of the wear rate and need for replacement at the end-life of the wearing parts may be reliably carried out. Patent application FI 20010673 discloses a data gathering system suitable for automatically issuing a replacement order for a wearing part on the basis of the information obtained from a sensor.

The wear of a crusher wearing part may alternatively be monitored by acoustic means using, e.g., an ultrasonic sensor. Herein, the amount of erosion is detected by way of utilizing the reflective properties of the outer surface of the wearing part.

Still further alternatively, a strain gage can be used as a sensor, whereby the deformation of the wearing part due to its erosion is utilized to determine the amount of erosion.

The wear monitoring and control system according to the invention is able to maintain a constant setting of a crusher thus assuring a uniform quality of the final product from the crusher. The system is easy to manage as compared with a conventional arrangement and, moreover, wear information can be retrieved readily and safely without needing the operator to climb onto the crusher. Measurement takes place continually without any shutdown in production. This allows the wearing parts of the crusher to be exploited “down to the last inch” without the fear of wear-out of the wearing parts and a resultant damage to the crusher. Based on the information delivered by the system, the user can establish an automatic ordering system of spare parts that gives an additional benefit of an optimized spare parts inventory. Moreover, variations in the erosiveness of the infeed material will not cause unexpected surprises.

More specifically, the method according to the invention is characterized by what is stated in the characterizing part of claim 1, the apparatus according to the invention is characterized by what is stated in the characterizing part of claim 3 and the wear sensors and wear sensor instrumentation according to the invention are characterized by what is stated in the characterizing parts of claims 9, 11 and 16.

In the following, the invention will be examined in more detail by making reference to the appended drawings in which

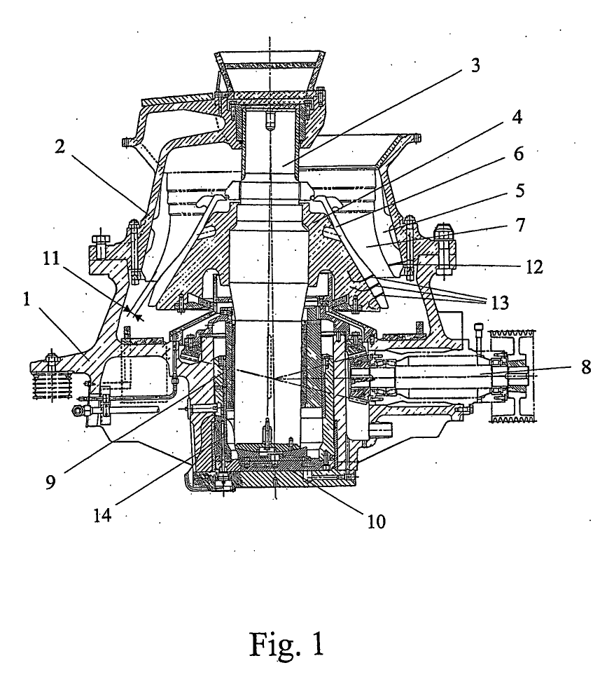

FIG. 1 shows a typical prior-art gyratory crusher equipped with wear sensors according to the invention;

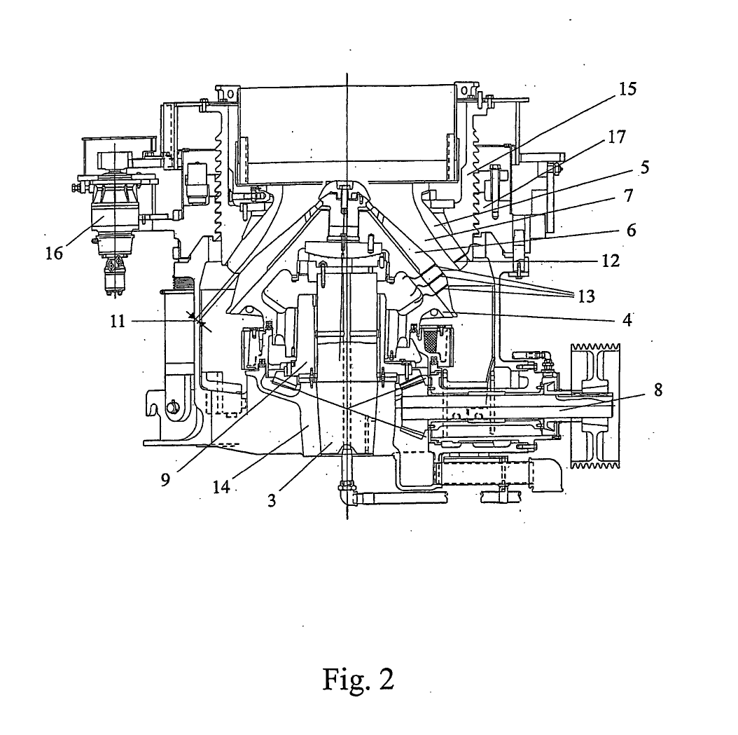

FIG. 2 shows a typical prior-art cone crusher equipped with wear sensors according to the invention;

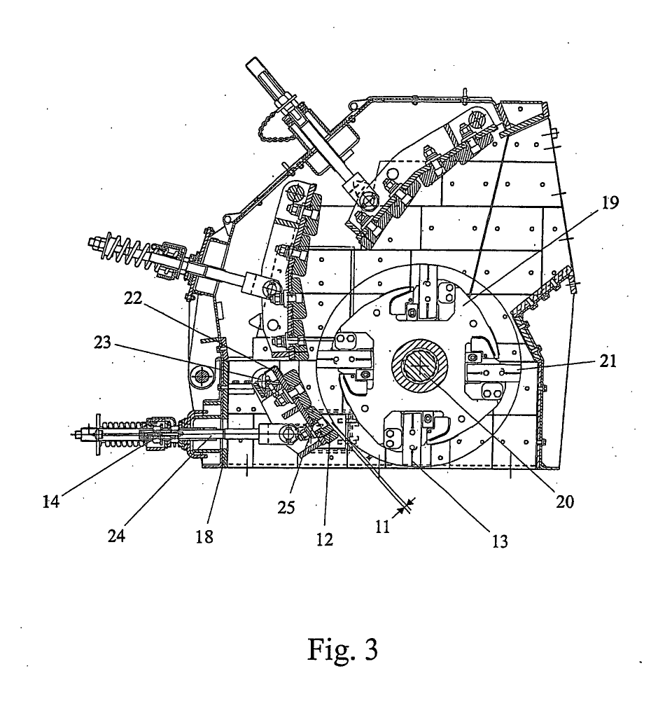

FIG. 3 shows a typical prior-art impact crusher equipped with wear sensors according to the invention;

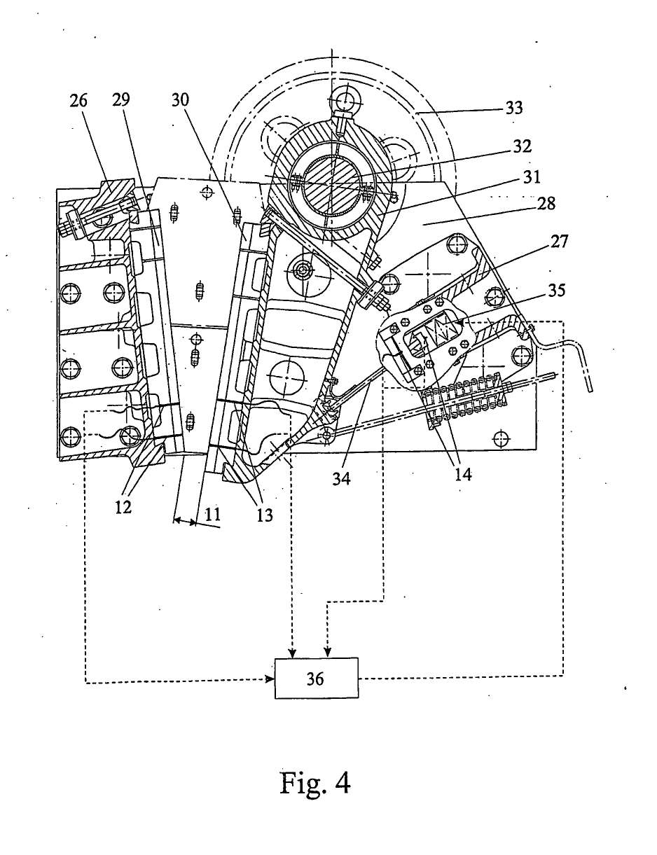

FIG. 4 shows a typical prior-art jaw crusher equipped with a control system according to the invention;

FIG. 5 shows the structure of the wearing portion of a wear sensor according to the invention;

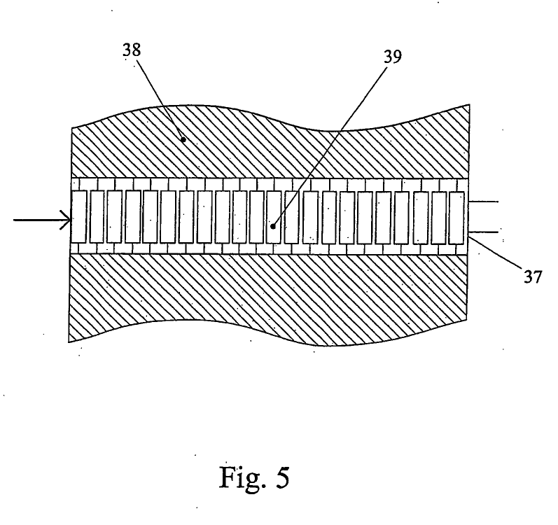

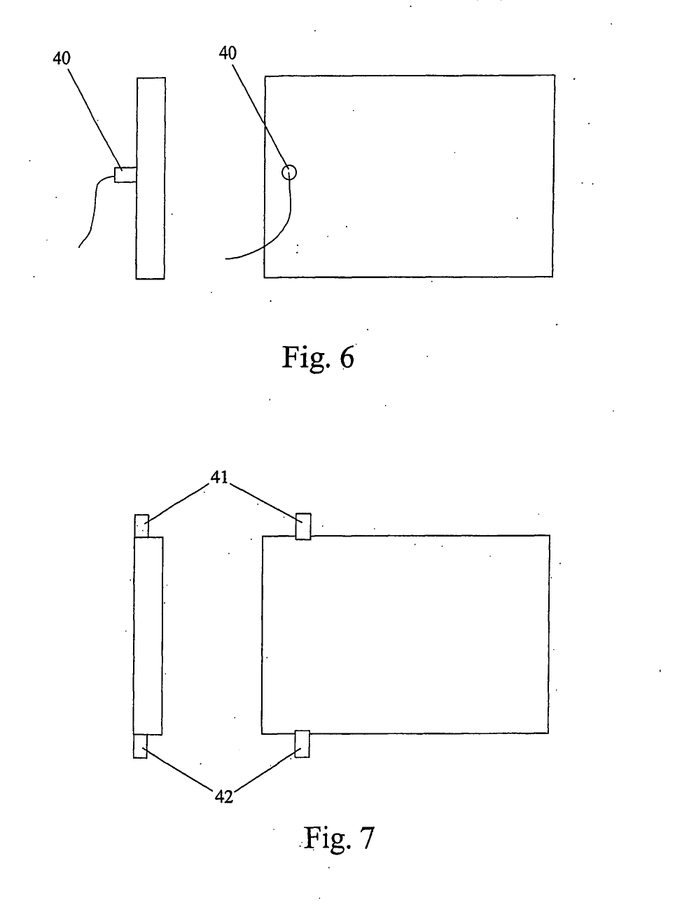

FIGS. 6 and 7 show exemplary embodiments of the location of ultrasonic sensors in the wearing part of a crusher; and

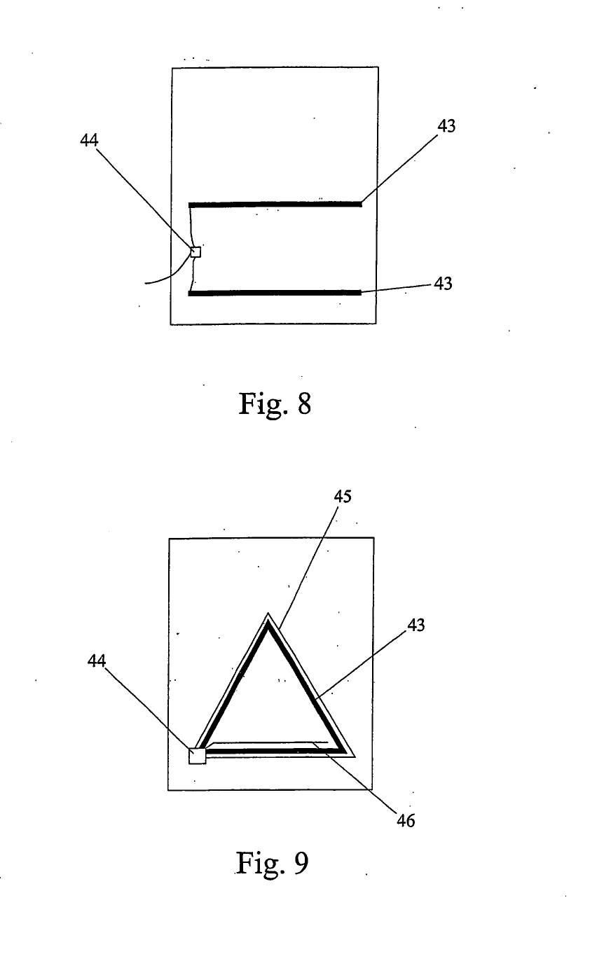

FIGS. 8 and 9 show exemplary embodiments of the location of strain-gage sensors in a wearing part of a crusher.

Referring to FIG. 1, the main components of the crusher shown therein comprise a lower frame 1, an upper frame 2, a main shaft 3, a support cone 4, an outer liner 5, an inner liner 6, a crushing chamber 7, a drive shaft 8, an eccentric shaft 9 and a control cylinder piston 10.

The crusher frame comprises two main units: a lower frame 1 and an upper frame 2. In cooperation with each other, the upper liner 5 mounted on the upper frame and the lower liner mounted via the support cone 4 on the main shaft 3 define a crushing chamber 7 wherein the material to be crushed is fed from above the crusher.

To the lower frame is adapted a drive shaft 8 serving to actuate the eccentric shaft 9. Respectively, to the eccentric shaft is made a bore inclined in regard to the center axis of the crusher chamber so as to accommodate the main shaft 3 therein. Then, the rotation of the eccentric shaft by the drive shaft in the interior of the crusher frame causes the main shaft inserted in the bore of the eccentric shaft to perform an oscillatory motion.

The crusher setting 11, which is defined as the smallest mutual distance between the outer liner and the inner liner, is adapted adjustable by virtue of pumping a hydraulic medium into the cavity remaining between setting control piston 10 and lower frame 1.

The position of support surfaces of the crusher's liners in regard to each other is monitored by a setting sensor 14 by means of which the height of the control piston 10 relative to the lower frame 1 is determined. Knowing this setting, mathematical means can be applied to determine the position of the support cone 4 acting as the support surface of the inner liner 6 relative to the upper frame 2 acting as the support surface of the outer liner 5. Wear sensors 12, 13 placed in the positions of the liners shown in the diagram monitor the erosion of the wearing parts. Measurement signals from these sensors are transmitted to the crusher's setting control system described in conjunction with FIG. 4 in more detail later in the text.

The main components of the crusher construction shown in FIG. 2 are a frame 14, a bowl 15, a main shaft 3, a support cone 4, an outer liner 5, an inner liner 6, a crushing chamber 7, a drive shaft 8, an eccentric shaft 9, a control motor 16 and a setting adjustment ring 17. On the bowl acting as the support surface for the outer liner is mounted the outer liner, while on the support cone acting as the support surface of the inner liner is mounted the inner liner, whereby the two liners define a crushing chamber wherein the material to be crushed is fed from above the crusher.

Drive shaft 8 serving to actuate eccentric shaft 9 is adapted to the lower frame. Respectively, to the eccentric shaft is made a bore suitable for accommodating therein the main shaft 3 that is mounted fixedly on the crusher frame. Then, the rotation of the eccentric shaft by the drive shaft about the crusher main shaft causes the support cone mounted in bearings on the eccentric shaft to perform an oscillatory motion.

The crusher setting is adjustable by way of rotating the bowl with the control motor, whereby the bowl is elevated or lowered along the threads of the setting adjustment ring.

The position of the support surfaces of the crusher liners relative to each other is monitored based on the number of revolutions performed by either the control motor or the bowl itself or, directly, from the height position of the bowl. Wear sensors 12, 13 mounted on the crusher liners at locations shown in the diagram monitor the wear of the wearing parts. The measurement signals delivered by these sensors are transmitted along with the height position signal of the support surfaces to the setting control system of the crusher described in conjunction with FIG. 4 in more detail later in the text.

The impact crusher shown in FIG. 3 comprises a frame 18, a rotor 19, a rotor shaft 20, breaker bars 21, breaker plates 22, breaker plate shafts 23, breaker plate adjustment rods 24 and breaker plate wearing parts 25. The rotor equipped with breaker bars is mounted on the crusher frame via the rotor shaft. The breaker plates are solidly attached to the crusher frame at their one end by the breaker plate shaft and at their other end in an adjustable fashion by the breaker plate adjustment rods. The breaker plate surfaces are covered by wearing parts.

In the operation of an impact crusher, the material to be crushed is fed into the crusher via an opening made in the crusher frame 18, wherefrom the aggregate material either rolls or falls onto the rotating breaker rotor 19. The rotor is equipped with breaker bars 21 that throw the material being crushed against the breaker plates 22. The crushing of the infeed material takes place at the impact of the aggregate material on the breaker bars of the rotor or on the breaker plates of the crusher frame or by the collision of the aggregates against each other. Latest in the gap between the last breaker plate in the travel direction of the aggregate material and the breaker bars of the rotor will be crushed a major portion of those material particles that when reaching this point are still larger than the breaker gap setting. The impact crusher shown in the diagram is equipped with three breaker plates, whereby the size of the aggregate material being crushed is comminuted stepwise at each one of the breaker plates into a smaller size equal to the gap setting at a given breaker plate. One end of the breaker plates is solidly connected to the crusher frame by the breaker plate shaft 23, while the other end of the breaker plates is connected via the breaker plate adjustment rod 24, each one of the rods serving to individually adjust the setting of its breaker plate. The position of the last breaker plate in the travel direction of the material being crushed determines the final gap setting 11 of the entire crusher. The outer surfaces of the breaker plates are equipped with breaker plate wearing parts 25 that serve as a breaker liner in cooperation with the breaker bars of the rotor.

The setting sensor 14 of the crusher is mounted on the adjustment rod of the last breaker plate in the travel direction of the material being crushed that controls the final gap setting of the entire crusher. This sensor delivers the setting signal of the adjustable support surface of the wearing part, that is, indicates the position of the breaker plate. The wear sensor(s) 12 of the wearing parts of a breaker plate are mounted on the wearing parts of the breaker that define the setting of the crusher. This wear sensor indicates the amount of erosion that has occurred in the wearing parts of the crusher. Respectively, the wear sensors 13 mounted on the breaker bars of the rotor indicate the wear that has occurred in the breaker bars of the rotor. The measurement data delivered by these sensors is transmitted to the crusher setting control system described in conjunction with FIG. 4 in more detail later in the text.

As shown in FIG. 4, the frame of the jaw crusher shown therein comprises a front frame 26, a rear frame 27 and side plates 28 connecting the frames. The crushing cavity is defined by a fixed jaw 29 mounted on the front frame, a moving jaw 30 connected to a pitman 31 and the side plates of the jaw crusher. The oscillation of the pitnan is actuated by an eccentric shaft 32 mounted eccentrically in bearings on both the pitman and the crusher side plates in cooperation with a flywheel 33 that is coupled to the eccentric shaft and is driven by external machinery. The gap width of the jaw opening known as the crusher setting is adjusted by changing the position of setting adjustment wedges 35 that via a toggle plate 34 control the crusher setting 11 which is the gap width between the lower edge of the movable jaw and the fixed jaw.

To the lower portions of both the fixed jaw and the movable jaw are adapted wear sensors 12, 13 capable of sending such measurement signals that the crusher's automatic control system 36 can based thereon monitor the wear of the jaws. The crusher's setting adjustment means are equipped with position sensors 14 capable of transmitting such position information that the automatic control system can based thereon determine the distance of the moving jaw support surface from the fixed jaw support surface. Based on the information submitted by the sensors, the control system can then determine in real time the actual setting of the crusher and the change therein due to wear, whereupon the control system is able to maintain the crusher setting at a constant value by virtue of adjusting the setting adjustment wedges according to the detected wear of the jaws.

In FIG. 5 is shown the structure of a wear sensor 37 embedded in a wear part 38 to be monitored, wherein the erosion takes place on the surface indicated by an arrow in the diagram.

The wear sensor is comprised of a network of resistors 39, wherefrom the resistors are eroded away from the resistor network as the sensor is worn along with the erosion of the wearing part being monitored. Having the isolated terminal of the resistor network connected to a constant voltage supply, the current through the resistor network can be computed from the following equation:
I=U/R,
where
U=voltage, and
R=overall resistance of resistor network.

With the erosion of the wearing part, the overall resistance of the sensor changes according to the following equation:
1/R=1/R₁+1/R₂+ . . . +1/Rₙ

whereby also the current through the sensor changes. Knowing the overall resistance of the resistor network and the detected change therein with the truncation of the network, the amount of erosion in the wearing part can be determined accurately by measuring the current passing through the sensor.

As to the function of the sensor shown in FIG. 5, proper selection of insulation material for the wear sensor is a vital issue. With regard to the insulation material selection, it is important to know the physical properties of the infeed material being crushed and the material of the wearing part. In an ideal case the sensor insulation material is selected to exhibit entirely identical erosion properties with the wearing part, whereby the infeed material causes erosion at entirely identical rates in both the wearing part proper and the wear sensor embedded therein. This situation, however, is hardly ever attained in practice inasmuch as the wear sensor invariably tends to be of either a harder and more brittle or, alternatively, of a softer and hence less wear resistant material than the wearing part proper, whereby there is the risk of abrupt sensor breakage/crushing or, respectively, rapid wear of the sensor.

In situations preferredly requiring an extremely hard sensor, its insulation material may generally be selected from the group of ceramic materials, for instance, that are usually only suitable for use as a hard-surface coating. One of such coatings is, e.g., thermally sprayed aluminum oxide. Under certain operating conditions the most advantageous choice may be a ceramic insulator made from an oxide powder bonded with a binder. As a result, a local breakage in this type of sensor does not cause a larger damage to the sensor. In other situations not primarily requiring a hard- surfaced sensor, the sensor may be made using a resilient insulation material such as a composite polymer material.

Irrespective of the insulation material selected, the sensor element is advantageously always made thin, whereby the impacts inside the crusher/breaker cannot cause a breakage of the sensor deeper than the eroded surface of the wearing part and, conversely, a projecting portion of the sensor will soon break down to the surface level of the wearing part if the erosion rate of the wearing part happens to be faster than the erosion rate of a hard-surfaced sensor.

In FIG. 6 is shown an exemplary embodiment of the adaptation of a self-contained ultrasonic sensor 40 in a wearing part of a crusher. This type of sensor system can be implemented using only a single sensor by virtue of embedding the sensor in the most wear-prone position of the wearing part or, alternatively, embedding a plurality of sensors in desired positions on the wearing part. When using self-contained ultrasonic sensors, the sensors are attached with threaded means or using a separate sensor mounting substrate adhered with the help of a joining compound tightly and orthogonally on the rear side of the wearing part. In operation, the sensor emits into the body of the wearing part an ultrasonic wavefront that is reflected from the opposite surface of the wearing part thus allowing the thickness of the wearing part at the monitored point to be determined.

In FIG. 7 is shown an exemplary embodiment of the placement of an alternative type of ultrasonic sensor on the wearing part of a crusher. Herein one edge of the wearing part is equipped with an ultrasonic transmitter 41 and on the opposite edge of the wearing part is mounted an ultrasonic receiver 42. This kind of sensor arrangement, possibly in combination with an intelligent sensor or an algorithm programmed in the software of the control system, facilitates the determination of the narrowest point of material thickness between the sensors.

Obviously, the ultrasonic sensors shown in FIGS. 6 and 7 can be replaced by sensors based on newer and more advanced ultrasonic sensor technologies. One of these alternatives is the so-called MEMS technology and sensors based thereon like detectors of acoustic emissions. These kinds of sensors are capable of measuring simultaneously both the material thickness and phenomena possibly undesirably occurring therein such as increase of cracks, permanent deformations, etc.

Additionally, all of the above-described sensors, as well as other kinds of sensors used in a control system according to the invention, may integrally incorporate both a self-contained power supply and an RF transmitter. In this fashion the sensor can be constructed into a self-contained entity capable of sending the measurement signal wirelessly to the crusher's control system located exterior to the crusher.

These kinds of sensors adapted externally mountable on the surface of the crusher's wearing parts allow the sensor to be readily transferred onto a new wearing part in conjunction with the replacement of the wearing part. Furthermore, a single sensor is sufficient for monitoring a plurality of variables characterizing the usability of a wearing part in a crusher.

In FIG. 8 is shown an exemplary embodiment of the placement of strain-gage type wear sensors on the wearing part of a crusher. Herein, the use of strain gage elements 43 as the wear sensor on a crusher wearing part is based on the fact that while the erosion of a wearing part causing the thinning thereof results only in a minor deformation, eventually the progressive erosion allows the rear side of the wearing part to become increasingly convex or concave. This deformation can be measured at a very high accuracy using a strain gage element of sufficient length. Moreover, a strain gage element permits simultaneous measurement of forces imposed on the wearing part during crushing.

Furthermore, product identification technology may readily be integrated with measurement circuitry based on strain gage sensors. Herein, a microcontroller 44 or the like unit required in conjunction with strain gage sensors for analysis of the measurement signal can also incorporate an ID code of the wearing part. This identification information is then easy to transmit along with the measurement data to the crusher's automatic control system over either a wired or wireless connection. The ID circuit may also be implemented using such technology that facilitates reading the ID code with the help of, e.g., a hand-held scanner suitable for wireless interrogation at a distance of a few meters from the crusher. The ID information may also be transmitted at a close range using a Bluetooth circuit. Using modern technology, it is possible to package the sensor amplifier, ID code circuit and the Bluetooth circuit in the size of half a credit card. Then, the identification information can be read using, e.g., a cellular phone as the reader.

Such an easy retrieval of component identification information gives the crusher operator a substantial aid in the definition and ordering of a required spare part as to its category and type.

The ID code of a wearing part may also be complemented with additional information about the wearing part that may be useful at later stages of the service life of the wearing part. For instance, the ID code may be complemented with such information on the metal alloy composition of the wearing part that can be utilized in the recycling of the wearing part. Other like information includes, e.g., the dimensions, weight and similar data of the wearing part.

In FIG. 9 is shown an exemplary embodiment of the placement of strain-gage type wear sensors operating as a fully self-contained entity. The sensor entity comprises a strain gage sensor 43, an energy capturing antenna 45, an integrated intelligent sensor circuit 44 and an RF antenna 46.

The measurement data obtained from the strain gage sensor 43 is gathered by the intelligent sensor circuit 44 that transmits the gathered information via the RF antenna 46 wirelessly to the crusher's control system situated exterior to the crusher. The operating energy of the integrated sensor package is captured with the help of an antenna 45 from an electromagnetic field surrounding the crusher unit. The functions of the intelligent sensor circuit comprise the conditioning of the operating energy captured by the antenna, processing of the measurement data obtained from the strain gage sensor and transmission of the processed information via the RF antenna. Additionally, the intelligent sensor circuit is programmed to include the ID code of the wearing part proper.

In this fashion, combination of radio-frequency (RF) technology with strain-gage technology permits an integrated sensor entity to be configured into a single self-adhesive tag. The units of the sensor assembly may also be comprised of separate blocks that are adhered by glueing to the rear surface of the wearing part. After installation, the separate blocks are connected to a common intelligent sensor circuit.

By way of mounting the sensor assemblies of the above-described kind on the rear sides of the opposed wearing parts in a crusher, vital information can be submitted to the control system of the crusher for accurate setting determination of the crusher, whereby the crusher may be controlled so as to maintain its setting at a desired value irrespective of the erosion of its wearing parts.

The invention is not limited to any given type of crusher, but instead may be adapted to all kinds of crushers equipped with wearing parts.

Further, the invention is not limited to the sensor constructions described above, but instead a crusher adjustment and control system according to the invention may utilize all types of such sensors that are capable of submitting sufficient information as input signals to the control system.

What is claimed is:

1. A method for measuring and monitoring the setting of a crusher during the crushing process, in which method the erosion of the wearing parts of a crusher is measured and the setting of a crusher is adjusted based on the measurement result so as to maintain the setting at a predetermined value irrespective of the erosion of the wearing parts, characterized in that the measurement data indicating the amount of erosion in said wearing parts of the crusher is transmitted wirelessly to the exterior side of the crusher.

2. The method of claim 1, characterized in that a wearing part replacement order is automatically issued as soon as the measurement data indicating the amount of erosion in the wearing parts reaches a predetermined threshold value.

3. An apparatus for measuring and monitoring the setting of a crusher during crushing, the apparatus comprising at least one wear sensor mounted on a crusher liner, means for adjusting the crusher setting, at least one sensor mounted on said means for adjusting the crusher setting and an automatic control system of the crusher, in which apparatus said crusher's automatic control system receives a first input signal from a wear sensor mounted on at least one liner of the crusher, said first input signal being suitable for determination of amount of erosion in said liner, and a second input signal from said sensor mounted on the setting adjustment means of the crusher, said second input signal being suitable for determination of the relative position of the support surfaces of the crusher's wearing parts, whereby the crusher's automatic control system is able based on both input signals to adjust the crusher setting so as to maintain the setting of the crusher in its predetermined value irrespective of the erosion of the wearing part, characterized in that at least one wear measurement sensor is mounted on each one of the crusher liners, and that said sensors are equipped with means for transmitting the measurement data wirelessly to the exterior side of the crusher.

4. The apparatus of claim 3, characterized in that the crusher's automatic control system includes means for receiving said wirelessly transmitted data.

5. The apparatus of claim 3 or 4, characterized in that said sensors are equipped with means for generating the electrical energy required for the operation of the sensors.

6. The apparatus of claim 5, characterized in that said means for generating the electrical energy required for the operation of the sensors comprise elements suitable for converting kinetic energy into electrical energy.

7. The apparatus of claim 5, characterized in that said means for generating the electrical energy required for the operation of the sensors comprise a piezoelectric device.

8. The apparatus of claim 5, characterized in that said means for generating the electrical energy required for the operation of the sensors comprise means for generating energy from an electromagnetic field surrounding the crusher.

9. A sensor suitable for use in any one of the apparatuses disclosed in claims 3-8 for measuring the amount of erosion in the wearing parts of a crusher, characterized in that the wearing portion of the sensor comprises a resistor network formed by a plurality of resistors in parallel, whereby the resistors along with the erosion of the wearing part in the crusher become erosively disconnected from the resistive network thus changing the overall resistance of the circuit feeding current to the wear sensor, whereby a measurement signal proportional to the amount of erosion in the wearing part is generated.

10. A sensor suitable for use in any one of the apparatuses disclosed in claims 3-8 for measuring the amount of erosion in the wearing parts of a crusher, characterized in that the wearing portion of the sensor comprises a resistor network formed by a plurality of resistors in series, whereby the resistors along with the erosion of the wearing part in the crusher become erosively disconnected from the resistive network thus changing the overall resistance of the circuit feeding current to the wear sensor, whereby a measurement signal proportional to the amount of wearing part erosion is generated.

11. A sensor suitable for use in any one of the apparatuses disclosed in claims 3-8 for measuring the amount of erosion in the wearing parts of a crusher, characterized in that the sensor is implemented such that the sensor utilizes acoustic waves.

12. The sensor of claim 11, characterized in that the sensor is an ultrasonic sensor.

13. The sensor of claim 11, characterized in that the sensor is implemented using MEMS technology in the sensor construction.

14. The sensor of claim 13, characterized in that the sensor is an acoustic emission detecting sensor.

15. The sensor of any one of claims 11-14, characterized in that the sensor incorporates separate means for emitting and receiving a sensing impulse.

16. A sensor suitable for use in any one of the apparatus disclosed in claims 3-8 for measuring the amount of erosion in the wearing parts of a crusher, characterized in that the sensor is based on a strain gage element.

17. The sensor of claim 16, characterized in that the sensor is also capable of measuring forces imposed on the wearing part during crushing.

18. The sensor of claim 16 or 17, characterized in that the sensor incorporates means for storing and wirelessly transmitting the identification data of the wearing part.

19. The sensor of any one of claims 16-18, characterized in that RF technology is used in the implementation of at least a portion of the sensor elements.
